(19) United States
(12) Patent Application Publication
(10) Pub. No.: US 2015/0271311 A1
(43) Pub. Date: Sep. 24, 2015

(54) Independent Smart Headset Networked Via Wireless Mobile Telecommunications Technology

(71) Applicant: ChangZhou Xing Ju Network Technology Co., Ltd., Changzhou City (CN)

(72) Inventor: Ge CHEN, Beijing (CN)

(73) Assignee: ChangZhou Xing Ju Network Technology Co., Ltd.

(21) Appl. No.: 14/570,621

(22) Filed: Dec. 15, 2014

(30) Foreign Application Priority Data
Mar. 18, 2014 (CN) 201410101280.5

(51) Int. Cl. H04M 1/725; H04R 1/08; H04R 1/10; H04M 1/02

(52) U.S. Cl. CPC H04M 1/7253; H04M 1/0277; H04R 1/08; H04R 1/1008; H04W 88/06

(57) ABSTRACT

The present invention relates to an independent smart headset apparatus networked via mobile wireless technology. The apparatus may comprise of a host portion and a headset portion. The host portion can include, among other things, a printed circuit board, a tactile sensor board, a user interface, a power source, a memory card, a wireless mobile telecommunications (e.g., 3G or 4G) module, a wireless local area network (e.g., WiFi) module, and a wireless data exchange (e.g., Bluetooth®) module. The headset portion can include a tactile sensor device, a matching wireless data exchange (e.g., Bluetooth®) module, a power source, a left earshell, a right earshell, a microphone (MIC), and an audio cable interface. The independent smart headset apparatus can also utilize a mobile operating system (e.g., Android™). The present invention improves over the current generation of music listening and socializing devices that require multiple independent devices.

### FIELD OF INVENTION

The present invention relates to an independent, stand-alone smart headset that can be based on a mobile operating system (OS), such as an Android™ operating system and networked via wireless mobile telecommunications technology such as 3G or 4G technology.

### BACKGROUND

Currently, listening to music via a headset needs a headset device, a music-playing device, and an audio cable device connecting the headset to the music-playing device; or alternatively, the headset and the music playing device can be provided with a wireless data exchange technology module, such as a Bluetooth® technology module, through which the headset can be connected to the music-playing device. In both ways, the user can operate the music-playing device to play music. The headset is utilized as an accessory, and listening to music via a headset requires three independent devices: a headset, an audio cable and a music-playing device. Existing headsets cannot play music independently, which render current music Device—headset combinations cumbersome and costly. There is a need for new and improved headset devices.

### SUMMARY OF INVENTION

Smart headset of the present invention is defined as a type of headset that incorporates smart headset technology analogous to that of a smartphone. Likewise, host (or smart host) as described in the invention refers to a device that fits into a headphone shell which utilizes user interface technologies similar to that of a smartphone. Currently, there are few, if any, smart headsets. With the independent (i.e. stand-alone) smart headset apparatus using an operating system (OS) and networked via wireless mobile telecommunications technology of the present invention, online or offline music playing, online messaging, and socializing at any time and any place can be realized using a completely independent networked device. This is an improvement over currently known headset devices where playing music, messaging and socializing have conventionally required a headset device in combination with another external device such as the cellular phone, tablet, or other audio playing device. The present invention simplifies human-computer interaction, realizes online or offline music playing and online messaging and socializing at any time and at any place.

In order to achieve the aforementioned aim, there is provided in an embodiment of the present invention, an independent smart headset apparatus networked via wireless mobile telecommunications technology, such as 3G or 4G technology, and said independent smart headset apparatus includes a host and a headset portions.

In an embodiment, the host may be an electronic component including a printed circuit board, such as printed circuit board assembly (PCBA) board, a tactile sensor such as a touchpad (IP) board, a user interface such as a light-emitting diode (LED) screen, a power source such as a battery, an insertion slot for a type of removable card device such as a Micro card slot, an interface for communication and power supply between computers and electronic devices such as an industry standard Micro USB interface, and physical function keys or buttons.

In an embodiment, the PCBA board may be embedded with a memory card such as an 8 gb memory card in a removable memory card insertion slot, a wireless (e.g., 3G) module, a local area wireless technology module such as WiFi or wireless local area network (WLAN) module, and a wireless data exchange technology module, such as a Bluetooth® module.

In an embodiment, the headset portion can include a touchpad, a wireless technology standard module, such as a Bluetooth® module, a battery, a left earshell, a right earshell, a microphone (MIC), and an audio cable interface.

Two magnet contacts located on the rear portion of the host and two magnet contacts placed in the right earshell of the headset are attracted to each other such that the host magnetically attaches to the headset.

An embodiment of a control feature found in the smart headset device regarding data communication between the host and headset portions such as battery power-on (BAT), ground (GND), Bluetooth® on (BT-ON), and Bluetooth® pair (BT-PAIR), can be realized by connecting four metal contacts in the right earshell with four metal wafers on the back of the host.

In an embodiment, the wireless technology standard module such as the Bluetooth® module in the left earshell of the headset matches the wireless module (e.g., Bluetooth®) on the PCBA board of the host, allowing transmission of data and audio signals between the host and the headset.

The touchpad on the left earshell of the headset controls the source of audio in the host.

In an embodiment of the networked independent smart headset apparatus described above, the PCBA board of the host can be embedded with a wireless mobile telecommunications technology module, such as a 3G module, and a local area wireless technology module, such as a WiFi module, to realize an independent network connection.

In an embodiment of the networked independent smart headset apparatus described above, the host portion can be provided with a type of individual user identification component or subscriber identity module (SIM) data card slot. When a SIM card or data card is inserted into the slot, the apparatus can be connected to a network via the wireless mobile telecommunications technology module such as a 3G module.

In an embodiment of the networked independent smart headset apparatus described above, the host portion can include a customized mobile operating system, such as an Android™ operating system to support running of software.

In an embodiment of the networked independent smart headset apparatus described above, the host portion can include music and radio software application (Apps), providing access to unlimited online music sources.

In an embodiment of the networked independent smart headset apparatus described above, the host portion includes an instant messaging and online social network applications (Apps), providing an online interactive social media platform and experience.

In an embodiment of the networked independent smart headset apparatus described above, the PCBA board of the host portion includes a memory card, for example an 8 gb memory card, for storing and playing music.

In an embodiment of the networked independent smart headset apparatus described above, the PCBA board of the host portion can include a wireless signal emission module (e.g., Bluetooth®), capable of communicating with a wireless signal receiving module (e.g., Bluetooth®) of the headset portion when the host is activated, such that the transmission of audio data and audio signals between the host and the headset do not break when the host is separated from the headset.

### BRIEF DESCRIPTION OF DRAWINGS

The foregoing summary and detailed description can be better understood where read in conjunction with the accompanying drawing, which is included by way of example. A more detailed description of illustrative embodiments of the present invention with reference to the accompanying drawing, the above described and any other aspects and merits of the present invention is provided.

FIG. 1 is a schematic of the exploded structure of an independent smart headset based on a mobile operating system, such as an Android™ operating system and networked via wireless mobile telecommunications technology, such as 3G or 4G technology.

### DETAILED DESCRIPTION OF INVENTION

The present invention will now be fully described with reference to the accompanying drawing. Various embodiments are illustrated in the drawings. However, the present invention may be implemented in various manners and shall not be interpreted as being limited in the illustrated embodiments. On the contrary, The presentation of those embodiments renders the present disclosure thorough and complete, and the scope of the present invention may be fully delivered to persons skilled in the art

Illustrative embodiments of the present invention are described with reference to the accompanying drawings.

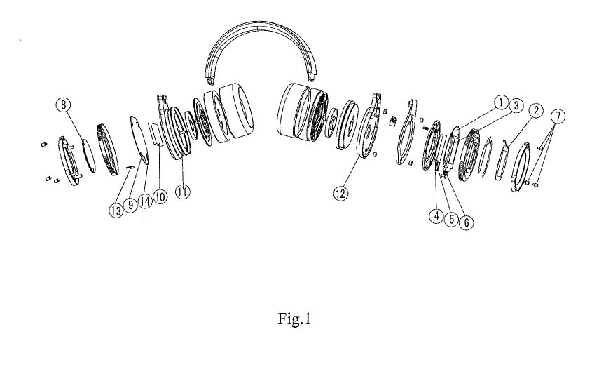

Referring to FIG. 1, an independent smart headset based on a mobile operating system, such as an Android™ operating system and networked via wireless mobile telecommunications technology, such as 3G or 4G technology is shown, which includes a host (a) and a headset (b).

The host (a) portion can comprise of a printed circuit board assembly (PCBA) board (1), a touchpad (TP) board (2), a light-emitting diode (LED) screen (3), a battery (4), a Micro card slot (5), a Micro USB interface (6), and three physical function keys (7). The PCBA board (1) is embedded with a memory card of a suitable capacity, such as 8 gb memory card, a wireless mobile telecommunications (e.g., 3G) module, a local area wireless technology (e.g., WiFi) module, and a wireless data exchange (e.g., Bluetooth®) module.

The headset (b) portion can comprises of a touchpad (8), a Bluetooth® module (9), a battery (10), a left earshell (11), a right earshell (12), a microphone (MIC) (13), and an audio cable interface (14).

Two magnet contacts on the rear portion of the host (a) and two magnet contacts in the right earshell (12) of the headset (b) are attracted to each other, such that the host (a) magnetically attaches to the headset (b).

Battery (BAT), ground (GND), Bluetooth® on (BT-ON), Bluetooth® pair (BT-PAIR) control features of the host (a) and the headset (b) portion are realized via four metal contacts in the right earshell (12) and four metal wafers on the back of the host which allow data communication between the host portion and the headset portion (a).

Audio signal transmission between the host (a) and the headset (b) is realized by matching the wireless signal emission (e.g., Bluetooth®) module (9) in the left earshell (11) of the headset with the Bluetooth® module on the PCBA board (1) of the host (a).

The touchpad (8), which can be positioned on the left earshell (11) of the headset (b) can be used to control the source of audio in the host (a).

When a subscriber identity module (SIM) card or data card is inserted into a Micro card slot (5), the host (a) can automatically connect to the network via the wireless mobile telecommunications technology (e.g., 3G) module on the PCBA board (1); or the host (a) automatically connects to the network via a local area wireless technology module such as the WiFi module on the PCBA board (1).

The host (a) can include a music radio software application (App), and music can be played online or offline without limitations via the music radio application (App).

With a memory card (e.g., with 8 gb memory card) embedded in the PCBA board (1), the user may store audio files via an interface for communication, power supply between computers and electronic devices such as an industry standard Micro USB interface (6), and play music via an audio playing application (App) preinstalled in the host (a).

For the independent smart headset based on a mobile operating system, such as an Android™ system and networked via wireless mobile telecommunications technology such as 3G or 4G technology, the host (a) can include an instant messaging and online social applications (Apps), and when the host (a) is connected to a network, the user can easily carry out online messaging and socializing via text and voice. In an embodiment, the host (a) can be readily detached from the headset (b), overcoming the cumbersome interface issues associated with human-computer interaction.

The independent smart headset based on a mobile operating system (e.g., Android™ OS) and networked via wireless mobile telecommunications (3G or 4G) technology can be connected to other music playing devices such as a cellular mobile phone, tablet and the like through the audio cable interface (14) via an audio cable when the host (a) is shut off.

The independent smart headset, based on a mobile operating system and networked via wireless mobile telecommunications technology, realizes music playing without limitation and online messaging and socializing with one independent networked device; it also combines with the functions of audio playing devices such as headset, cellular phone, tablet and the like. It is unique in design, low in cost, convenient in performing human-computer interaction, and easy to carry.

Further, the human-computer interaction between the independent smart headset, based on a mobile operating system such as an Android™ system and networked via wireless mobile telecommunications technology such as 3G or 4G technology, can be operated via voice recognition control. That is to say, the user may directly send out a voice command via the microphone (MIC) (13) and the installed applications (Apps) may be automatically operated via the voice recognition function within the system, instead of having to detach the host (a) from the headset (b) to touch the light-emitting diode (LED) screen (13) and operate the applications (Apps) in the host (a) via the touchpad (TP) board (2).

With the independent smart headset based on a mobile operating system such as an Android™ system and networked via wireless mobile telecommunications technology such as 3G or 4G technology, an independent device may be automatically connected to the network and provide with unlimited music sources; the user may be able to listen to music at any time and any place, and perform online messaging and socializing at the same time. This replaces the more traditional way of utilizing a headset together with a cellular phone or tablet and the like to listen to music. In addition, online messaging and socializing via a smart headset device is realized.

The above are exemplary embodiments of the present invention, and are not intended to limit the present invention. Various modifications and changes may be made to the present invention. Any amendments, substitutions, improvements and the like made in the spirit and principle of the present invention shall be within the scope of protection of the present invention.

What is claimed:

1. An independent smart headset apparatus connected to a data network via wireless technology, which is comprised of:
a host and a headset portions;
the host portion comprising: a printed circuit board, a tactile sensor board, a user interface, a power source, a memory storage device, an interface for communication and power supply, and a mechanical component;
the printed circuit board including a memory card, a wireless mobile telecommunications module, a wireless local area network module, and a wireless data exchange module;
the headset portion comprising: a tactile sensor device, a wireless data exchange module, a power source, a left earshell, a right earshell, a microphone, and an audio cable interface;
wherein the host and the headset portions are releasably attached at the rear portion of the host and in the earshells of the headset;
wherein the host portion and the headset portion's data communication is controlled using contacts in the right earshell or the left earshell that align with contacts on the back of the host; and
wherein, a wireless data exchange module in an earshell of the headset communicates wirelessly with the wireless data exchange module on the printed circuit board in the host allowing data exchange or signal transmission between the host and the headset;
wherein an audio source in the host is controlled using the tactile sensor device.

2. The independent smart headset apparatus according to claim 1, comprising:
a printed circuit board in the host including a wireless mobile telecommunications module and a wireless local area network module, wherein the wireless mobile telecommunications module is a 3G or 4G module and the wireless local area network module is a WiFi module.

3. The independent smart headset apparatus according to claim 1, wherein the host portion further includes a removable card slot, holding a type of individual user identification component card or data card, allowing the host portion to connect to a data network via a wireless mobile telecommunications module.

4. The independent smart headset apparatus according to claim 3, wherein the type of individual user identification component card or data card is a subscriber identity module (SIM) card.

5. The independent smart headset apparatus according to claim 1, wherein the host portion includes a customized mobile operating system to support the running of software applications.

6. The independent smart headset apparatus according to claim 1, wherein the host portion includes a type of audio software application that can access online music sources.

7. The independent smart headset apparatus according to claim 1, wherein the host portion includes at least one of an instant messaging software application or an online social platform software application.

8. The independent smart headset apparatus according to claim 1, wherein the printed circuit board in the host portion includes a memory card for storing and playing music.

9. The independent smart headset apparatus according to claim 1, wherein the printed circuit board in the host portion includes a wireless data exchange module for transmission which communicates wirelessly with a wireless data exchange module for reception in the headset portion when the host is on, and maintains the transmission of data between the host and the headset.

10. The independent smart headset apparatus according to claim 8, wherein the host portion is detached from the headset portion and maintains the transmission of audio data between the host and the headset.
